(19) United States
(12) Patent Application Publication
(10) Pub. No.: US 2012/0024121 A1
(43) Pub. Date: Feb. 2, 2012

(54) ADJUSTABLE PRINT MEDIA CUTTER SYSTEM AND METHOD

(76) Inventors: Kim Balahan, Dumaguete City (PH); Shao Hwa Lee, Singapore (SG); Wee Hian Khor, Singapore (SG)

(21) Appl. No.: 12/847,412

(22) Filed: Jul. 30, 2010

(51) Int. Cl. B26D 7/26

(52) U.S. Cl. 83/13; 83/561

(57) ABSTRACT

An adjustable print media cutter system and method are disclosed. In one form, the print media cutter system incorporates a blade assembly and an anvil assembly that are configured to provide an adjustable gap between a cutting blade and an anvil. Rotation of an adjustment cam adjusts the gap between the cutting blade and the anvil, thereby adjusting a depth of cut made into or through a print media that is fed between the blade assembly and the anvil assembly during operation of the adjustable print media cutter system.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The present invention relates to an adjustable print media cutter system and method, and more particularly to a cutter system for a printer that is adjustable to accommodate print media of various form factors and to provide control over the depth of a cut made into or through the print media.

Print media is available in a variety of forms. For instance, printers have been developed to print on adhesive backed paper sheets and flattened tubing. Each type of print media may further be of an almost infinite number of shapes and sizes. Tubing, for example, can vary in both overall diameter as well as wall thickness. Print media, especially in commercial application settings (e.g., wire labels), is often stored in cartridge or roll forms that have a spool of print material in a continuous sheet or strip that is fed past a print head of a printer. A cutter, often integrated with the printer, is then used to cut the print media to the desired size and shape.

In certain instances, it may be desirable to score or partially cut through the print media. As one example, tubing may have serialized or other individualized print. Separating each individual tube segment as it is printed increases the potential that a tube segment will be misplaced. To remedy this situation, the print media (e.g., tubing) is partially cut or scored by the cutter, thus maintaining a continuous, ordered strip of printed upon print media that may be easily separated immediately before being applied in its final use.

While the benefits of controlling the cut depth through a print media are evident, the application of the concept leaves much room for improvement. The vast number of print media types, styles, and form factors requires adjusting the cut depth accordingly. Many current cutters that are integrated into printers use systems that vary the distance a cutting blade travels and/or incorporates protrusions/sleeves that provide for discrete cutting depth adjustment. These types of systems, and especially the protrusion/sleeve type, require that the cutter system be accessed and manually configured to adjust the depth of cut as the print media and desired depth change. Furthermore, should a complete cut through the print media be desired, typical arrangements require additional time-consuming modifications to provide this functionality.

A cutter that does not reliably perform the desired cut reduces the overall productivity and efficiency of the cutter and any printer into which it may be integrated. Returning to the tubing context, for instance, a cutter that does not provide a sufficient depth of cut will result in the tube portions being difficult to separate. Conversely, a cutter that provides too deep of a cut may reduce the structural integrity of the connection between adjacent tube portions such that the portions separate unintentionally during handling. Further complications may arise when considering that different tube diameters may require different cut depths to achieve the desired result. Thus, a certain depth of cut in one diameter tubing may not provide the same result in tubing having a different diameter.

Therefore, a need exists for an improved cutter system that is capable of use in a printer.

### SUMMARY OF THE INVENTION

In one aspect, an adjustable print media cutter system, capable of use in a printer, comprises a frame, a cutting blade slideably mounted to the frame along a cutting plane between a retracted position and an extended position, an anvil mounted to the frame adjacent the cutting blade and intersecting the cutting plane, a stopper positioned adjacent the cutting blade and the anvil to selectively inhibit relative movement between the cutting blade and the anvil along the cutting plane when the cutting blade is in the extended position, and an adjustment cam coupled to the frame and engaged with at least one of the anvil and the stopper. Rotation of the adjustment cam about an adjustment cam axis moves at least one of the anvil and the stopper along the cutting plane adjusting a gap between the cutting blade and the anvil that establishes a depth of cut by the cutting blade into or through a print media that is fed between the cutting blade and the anvil.

In another aspect, an adjustable print media cutter system, capable of use in a printer, comprises a frame, a cutting blade slideably mounted to the frame along a cutting plane between a retracted position and an extended position, an anvil slideably mounted to the frame along the cutting plane between a first gap position and a second gap position, and an adjustment cam rotatably coupled to the frame about an adjustment cam axis, and engaged with the anvil. Rotation of the adjustment cam about the adjustment cam axis moves the anvil along the cutting plane between the first gap position and the second gap position, thereby adjusting a gap between the cutting blade and the anvil that establishes a depth of cut by the cutting blade into or through a print media that is fed between the cutting blade and the anvil.

In yet another aspect, a method of adjusting a print media cutter system capable of use in a printer comprises providing a print media cutter system having a frame, a cutting blade slideably mounted to the frame along a cutting plane between a retracted position and an extended position, an anvil mounted to the frame adjacent the cutting blade and intersecting the cutting plane, a gap defined between the cutting blade and the anvil, and an adjustment cam rotatably coupled to the frame about an adjustment cam axis. Rotating the adjustment cam about the adjustment cam axis adjusts the gap between the cutting blade and the anvil.

These and still other aspects will be apparent from the description that follows. In the detailed description, preferred example embodiments will be described with reference to the accompanying drawings. These embodiments do not represent the full scope of the invention; rather the invention may be employed in other embodiments. Reference should therefore be made to the claims herein for interpreting the breadth of the invention.

### BRIEF DESCRIPTION OF THE DRAWINGS

FIG. 1 is a partial isometric view of a printer incorporating an example adjustable print media cutter system.

FIG. 2 is an isometric view of the example adjustable print media cutter system.

FIG. 3 is an isometric view of the example adjustable print media cutter system with a portion of the frame removed.

FIG. 4 is an isometric view of an example blade assembly.

FIG. 5A is an exploded isometric view of the example blade assembly of FIG. 4.

FIG. 5B is an exploded isometric view of an alternative example blade assembly.

FIG. 6 is an isometric view of an example anvil assembly.

FIG. 7A is an exploded isometric view of the example anvil assembly of FIG. 6.

FIG. 7B is an exploded isometric view of an alternative example anvil assembly.

FIG. 8 is a partial plan view of the example adjustable print media cutter system.

FIG. 9 is a partial isometric view of an example gear train of the example adjustable print media cutter system.

FIG. 10 is a partial detail view of the cutting blade in the extended position and the anvil in the maximum gap position.

FIG. 11 is a partial detail view of the cutting blade in the extended position and the anvil in an alternative gap position.

FIG. 12A is an isometric view of an example adjustment cam of the example adjustable print media cutter system.

FIG. 12B is an isometric view of an alternative example adjustment cam.

FIG. 13A is a plan view of the example adjustment cam of FIG. 12A.

FIG. 13B is a plan view of the alternative example adjustment cam of FIG. 12B.

FIG. 14 is a plan view of the example cutting cam of FIG. 5B.

FIG. 15 is a partial detail view of the cutting blade in the extended position and the anvil in the no gap or full cut position.

### DETAILED DESCRIPTION OF THE PREFERRED EXAMPLE EMBODIMENTS

An example adjustable print media cutter system will be described in combination with an example label printer. However, as one skilled in the art will appreciate, the example adjustable print media cutter system may be modified for use in a variety of different types and styles of printers, such as those manufactured by Brady Worldwide, Inc. of Milwaukee, Wis.

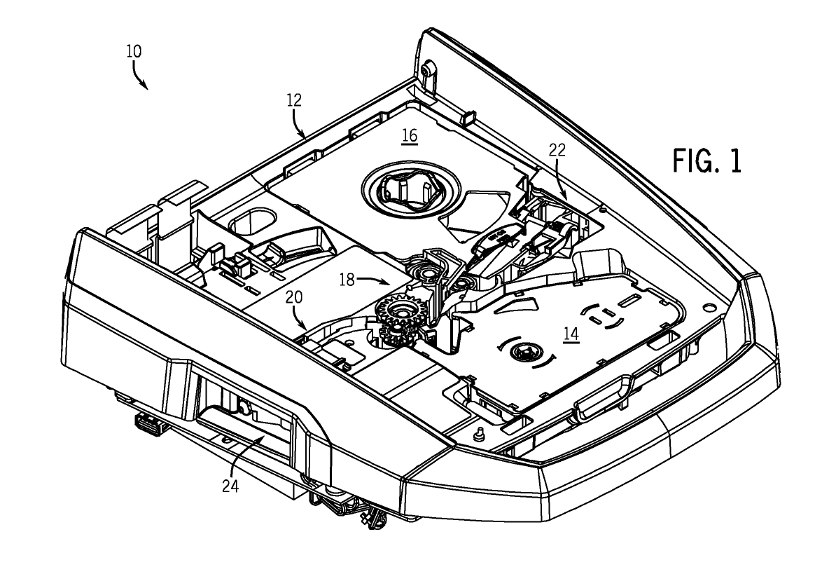

An example printer in the form of a label printer (10) is illustrated in FIG. 1. The top cover (including the printer controls) is removed to show the basic arrangement of the various components within the label printer (10). The label printer (10) generally includes a frame (12) supporting a ribbon cartridge (14), a print media cartridge (16), a print head assembly (18), and an example adjustable print media cutter system (“cutter system (20)”). The example print media cartridge (16) and the example ribbon cartridge (14) are selectively removable from the frame (12) of the label printer (10) to facilitate removal and replacement.

Print media (not shown), such as adhesive-backed labels, tubing, paper, plastic wire marker sleeves, and the like, is fed adjacent the print head assembly (18) as it is either unwound from the print media cartridge (16) or inserted into the label printer (10) via the external media input passage (22). The print head assembly (18) interacts with the ribbon cartridge (14) to print upon the print media. The print media is then directed downstream toward the example cutter system (20) whereat the print media may be cut or scored by the cutter system (20), as will be described below in greater detail, before being directed out of the label printer (10) through a media output passage (24).

As one skilled in the art will appreciate, the overall control and operation of the label printer (10) may be in accordance with standard printer design, with any modifications necessary to implement the inventive concepts. For instance, a controller may be incorporated to control the operation of various motors in response to sensors and instructions programmed through the printer controls. In another version, the label printer (10) may be in communication with a separate device (e.g., a portable computer or hand-held device) to receive any number of commands or instructions.

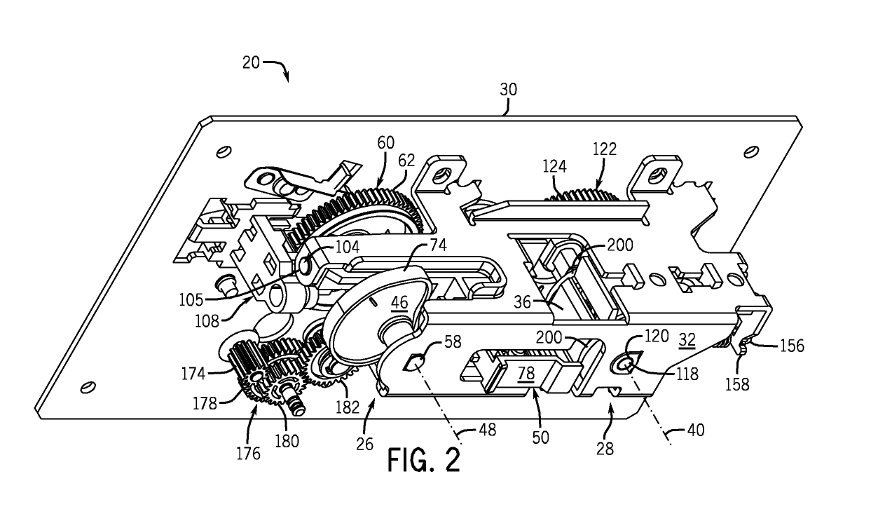

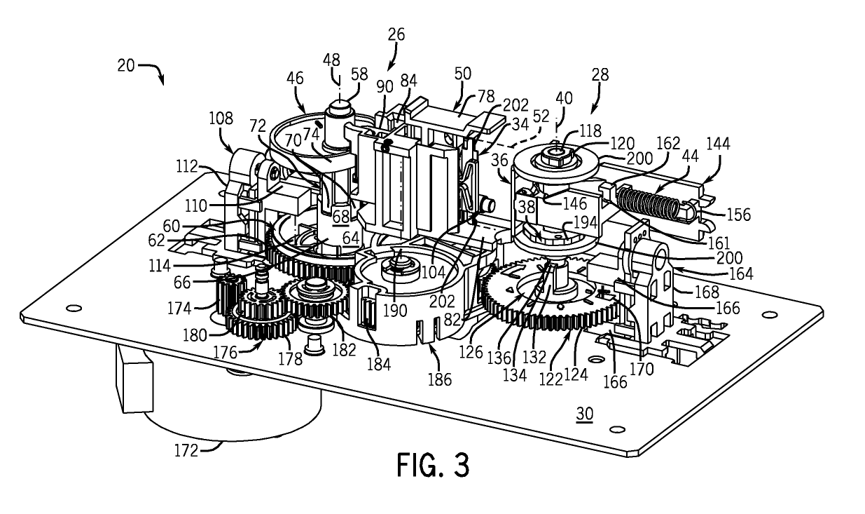

In FIGS. 2 and 3, the example cutter system (20) is shown removed from the balance of the label printer (10). The cutter system (20) generally includes a blade assembly (26) adjacent an anvil assembly (28), both of which are shown mounted to a support plate (30) portion of the frame (12). A cage (32) secures the blade assembly (26) and the anvil assembly (28) to the support plate (30). Various other components (e.g., fasteners) have been removed from FIGS. 2 and 3 for clarity.

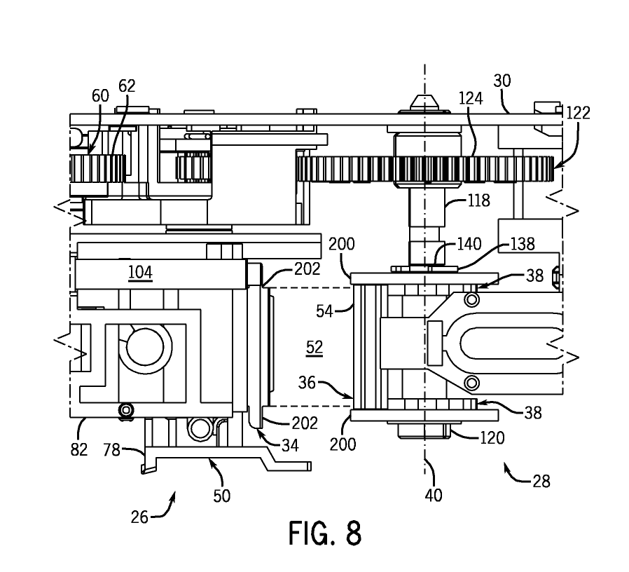

In general, the example cutter system (20) operates to slideably move a cutting blade (34) of the blade assembly (26) toward or against an anvil (36) of the anvil assembly (28). The example anvil assembly (28) is configured to allow a gap (56) between the cutting blade (34) and the anvil (36) to be adjusted by rotating a pair of adjustment cams (38) about an adjustment cam axis (40), depending upon a desired depth of cut into or through (thus completely closing the gap (56)) print media located between the cutting blade (34) and the anvil (36). As the adjustment cams (38) rotate, the anvil (36) is biased toward the adjustment cams (38) by a biasing member, shown in the form of an extension spring (44). With the anvil (36) positioned, the blade assembly (26) is moved from the retracted position (shown, for example, in FIGS. 3 and 8) toward the extended position (shown, for example, in FIGS. 10, 11, and 15) by rotating the cutting cam (46) about a cutting cam axis (48). The cutting cam (46) urges a blade holder (50), to which the cutting blade (34) is secured, toward the anvil (36) along a cutting plane (52). Depending upon the position of the anvil (36) (as established by the rotational position of the adjustment cams (38)), the cutting blade (34) may either engage a cutting surface (54) of the anvil (36) (i.e., a full cut closing the gap (56)) or be spaced apart from the cutting surface (54) defining a gap (56) there between (see, e.g., FIG. 10) when the cutting blade (34) is in the extended position.

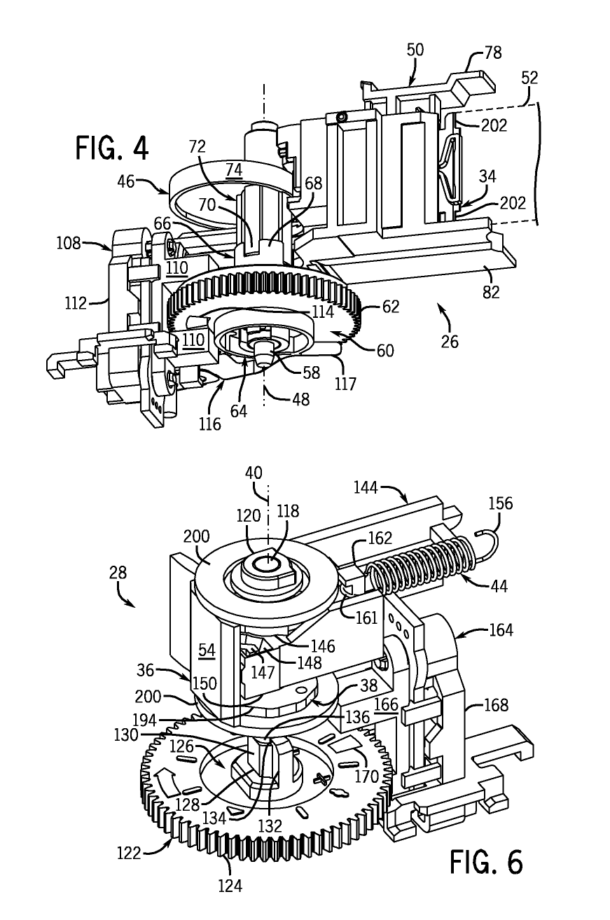

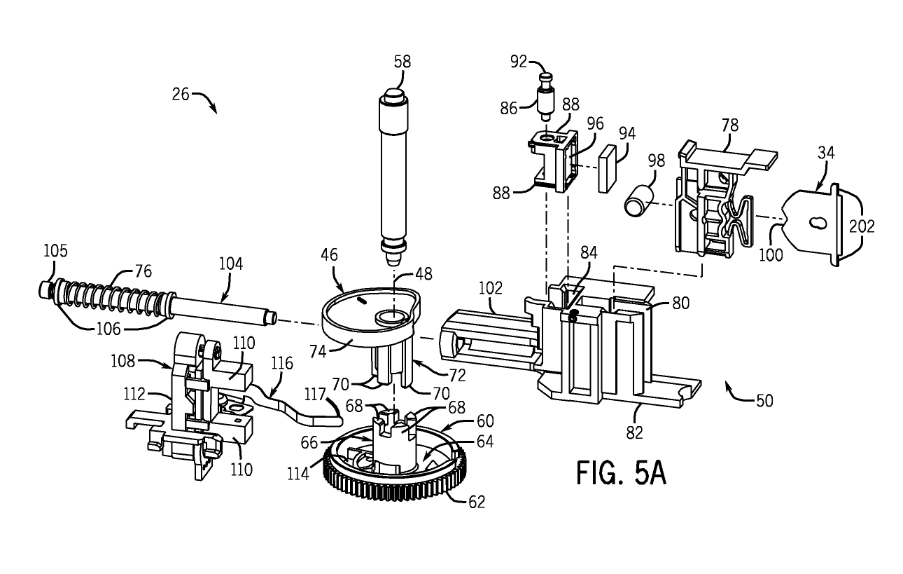

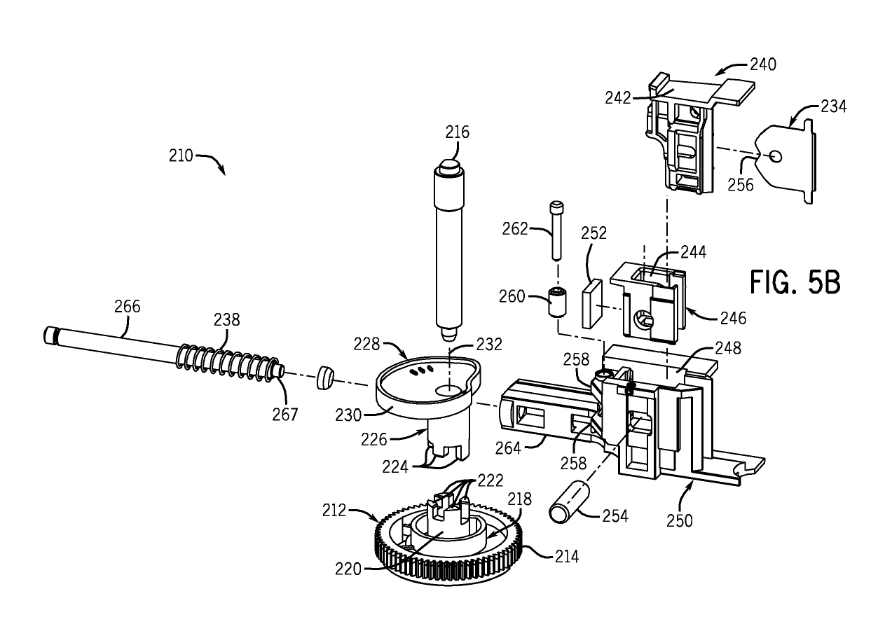

With additional reference to FIGS. 4 and 5A, the components of the example blade assembly (26) are described in greater detail. A pin (58) is secured to and extends away from the support plate (30). A cutting gear (60) having a plurality of teeth (62) is rotatably mounted to the pin (58) and positioned near the support plate (30). A central hub (64) of the cutting gear (60) includes a castellated portion (66) having several fingers (68) extending upward (as generally viewed in FIG. 5A) to engage mating fingers (70) extending downward from a castellated portion (72) of the cutting cam (46). The fingers (68, 70) of the respective castellated portions (66, 72) rotatably couple the cutting gear (60) and the cutting cam (46). The cutting cam (46) defines a lobed cam surface (74) that is generally non-uniformly spaced radially from the cutting cam axis (48). Thus, rotating the cutting cam (46) via the cutting gear (60) urges the cutting blade (34) along the cutting plane (52) toward the extended position. A biasing member in the form of a compression spring (76) urges the cutting blade (34) toward the lobed cam surface (74), allowing the cutting blade (34) to return to the retracted position when the cutting cam (46) is rotated accordingly.

In the example embodiment, the blade holder (50) includes a blade cartridge (78), that carries the cutting blade (34), which is slid into a slot (80) formed in a blade cartridge receptacle (82). As a result, the blade cartridge (78), and hence cutting blade (34), may be easily uninstalled and reinstalled. The blade cartridge receptacle (82) further includes a pocket (84) into which a bushing (86) is seated to engage the lobed cam surface (74) of the cutting cam (46). The bushing (86) is captured between arms (88) of a saddle (90) by a pin (92). A bearing block (94) is seated in a recess (96) formed in the saddle (90) and engages a barrel (98) sandwiched between the bearing block (94) and a v-shaped profile (100) of the cutting blade (34).

To establish generally linear movement of the blade holder (50) along the cutting plane (52), the blade cartridge receptacle (82) further includes a guide arm (102) through which a guide pin (104) extends. The guide pin (104) is fixed at one end (105) to the cage (32) (and thus relative to the blade cartridge receptacle (82)), such that the compression spring (76) positioned between a pair of collars (106) and surrounding the guide pin (104) is compressed as the blade cartridge receptacle (82) is urged toward the extended position by the rotating cutting cam (46). The compressed compression spring (76) then urges the blade cartridge receptacle (82) toward the retracted position as the cutting cam (46) is rotated accordingly.

In the example blade assembly (26), a position sensor in the form of an optical sensor (108) is secured to the support plate (30). Two arms (110) extend from a bracket (112) and flank the cutting gear (60). Specifically, the cutting gear (60) includes an opening (114) through the cutting gear (60) such that the optical sensor (108) may send a signal to a controller (not shown) of the label printer (10) when the opening (114) in the cutting gear (60) is aligned with the arms (110) of the optical sensor (108). As one skilled in the art will appreciate, a variety of sensors may be incorporated to determine the rotational position of the cutting gear (60). A resilient finger (116) is fixed to the support plate (30) and extends toward a distal end (117) to ride along a collar (not shown) of the cutting gear (60). The resilient finger (116) rests in an arc-shaped cutout (not shown) formed in the collar, thereby inhibiting unintended movement of the cutting blade (34).

The components of an alternative, preferred example blade assembly (210) are illustrated in FIG. 5B. A cutting gear (212) having a plurality of teeth (214) is rotatably mounted to a pin (216). A central hub (218) of the cutting gear (212) includes a castellated portion (220) having several fingers (222) extending upward (as generally viewed in FIG. 5B) to engage mating fingers (224) extending downward from a castellated portion (226) of a cutting cam (228). The fingers (222, 224) of the respective castellated portions (220, 226) rotatably couple the cutting gear (212) and the cutting cam (228). Again, the cutting cam (228) defines a lobed cam surface (230) that is generally non-uniformly spaced radially from a cutting cam axis (232). Thus, rotating the cutting cam (228) via the cutting gear (212) urges a cutting blade (234) along a cutting plane toward an extended position. A biasing member in the form of a compression spring (238) urges the cutting blade (234) toward the lobed cam surface (230), allowing the cutting blade (234) to return to the retracted position when the cutting cam (228) is rotated accordingly.

Similar to the first example blade assembly (26), a blade holder (240) includes a blade cartridge (242) that carries the cutting blade (234). Unlike the first example blade assembly (26), the blade cartridge (242) is slid into a slot (244) formed in an intermediate housing (246) that is in turn seated in a cavity (248) formed in a blade cartridge receptacle (250), allowing for the blade cartridge (242) to be uninstalled and reinstalled as needed. The intermediate housing (246) engages a bearing block (252) and a barrel (254). The barrel (254) is configured to engage a v-shaped profile (256) of the cutting blade (234). The blade cartridge receptacle (250) further includes a pair of arms (258) between which a bushing (260) is captured by a pin (262) to engage the lobed cam surface (230) of the cutting cam (228).

Again, similar to the first example blade assembly (26), the blade cartridge receptacle (250) further includes a guide arm (264) through which a guide pin (266) extends to establish generally linear movement of the blade holder (240) along the cutting plane. The guide pin (266) is fixed to the blade cartridge receptacle (250), such that the compression spring (238), captured between an end (267) of the guide pin (266) and the guide arm (264), is compressed as the blade cartridge receptacle (250) is urged toward the extended position by the rotating cutting cam (228). The compressed compression spring (238) then urges the blade cartridge receptacle (250) toward the retracted position as the cutting cam (228) is rotated accordingly.

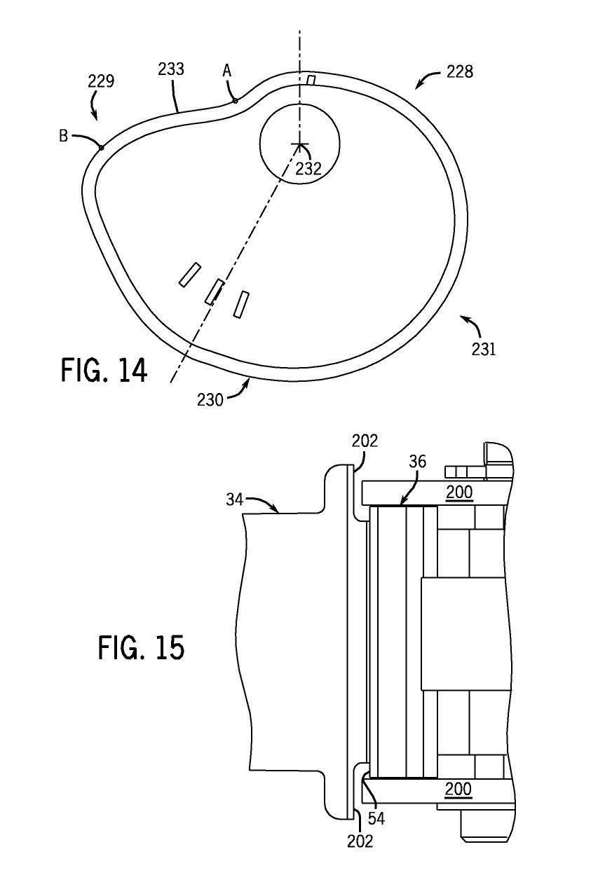

The cutting cam (228) (shown best in FIGS. 5B and 14) generally includes a lower torque region (229) and a higher torque region (231) of the lobed cam surface (230). The lower torque region (229) typically imparts relatively lower torque/higher speed operation as the lobed cam surface (230) includes a segment (233) that is “steeply” spaced apart from the cutting cam axis (232) between approximately point (A) and point (B) (i.e., the radial distance of the lobed cam surface (230) from the cutting cam axis (232) changes more substantially over a defined angular rotation/segment). The lower torque region (229) provides for relatively high speed movement of the cutting blade (234) as the cutting cam (228) is rotated, and generally has a lower torque capacity. The higher torque region (231) typically imparts relatively higher torque/lower speed operation as the lobed cam surface (230) is more gradually spaced apart from the cutting cam axis (232). The higher torque region (231) provides for relatively low speed movement of the cutting blade (234) as the cutting cam (228) is rotated, and generally has a higher torque capacity.

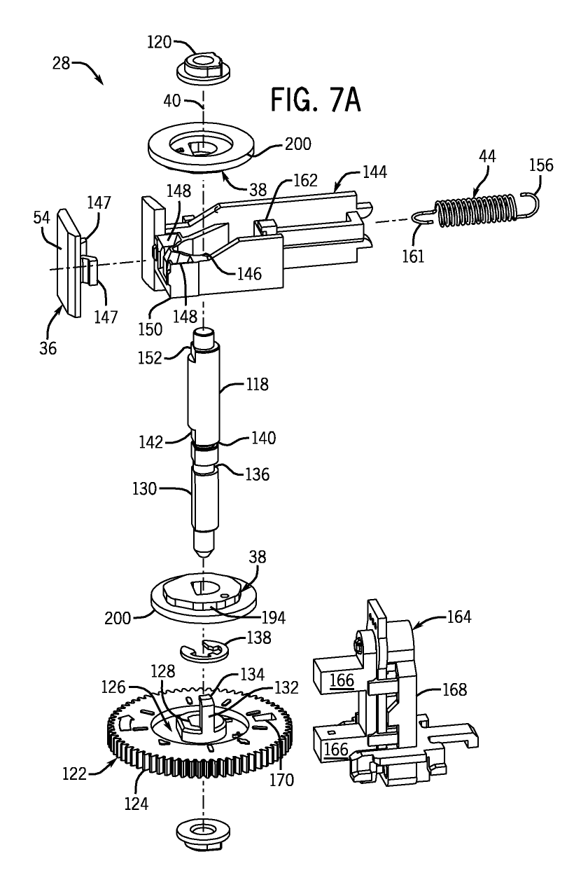

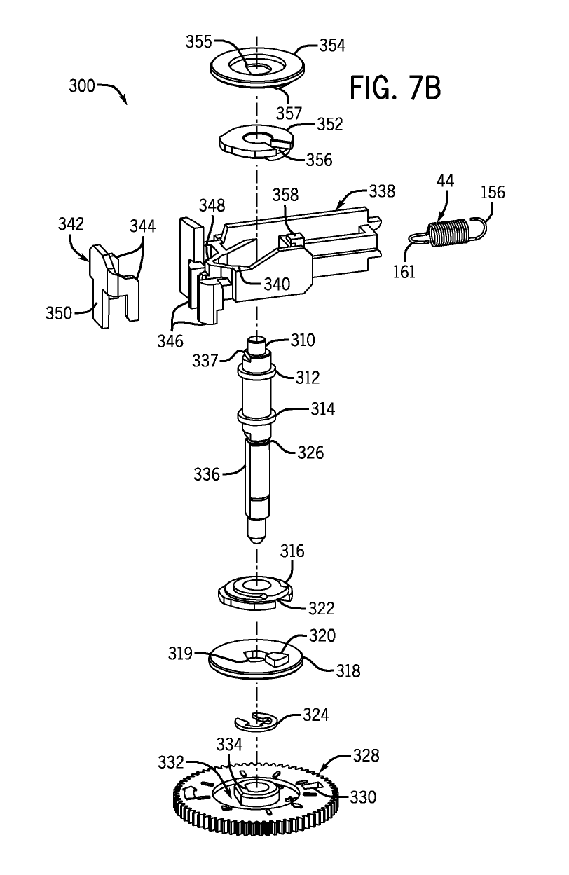

In the example cutter system (20), whether the cutting blade (34) cuts completely through the print media or only partially cuts through the print media is controlled by the anvil assembly (28). With specific reference to FIGS. 6 and 7A, the components of the anvil assembly (28) will be described in greater detail. A pin (118) is secured to the support plate (30) by an end cap (120). An adjustment gear (122) having a plurality of teeth (124) is rotatably coupled to the pin (118) and positioned near the support plate (30). A central hub (126) of the adjustment gear (122) includes a D-shaped opening (128) mating with a D-shaped portion (130) of the pin (118). A finger (132) extends upward (as shown in FIG. 7A) from the central hub (126) and terminates in a bent tip (134) that is seated in a groove (136) formed along the pin (118), thus axially retaining the adjustment gear (122) relative to the pin (118).

One of the adjustment cams (38) is positioned between an e-clip (138) secured in a groove (140) and a ledge (142) formed along the pin (118). A carriage (144) includes an opening (146) through which the pin (118) extends. The anvil (36) includes a pair of ears (147) that are seated into mating slots (148) formed in an end (150) of the carriage (144). The carriage (144) and anvil (36) are then captured between the pair of adjustment cams (38) as another adjustment cam (38) is seated in a notched portion (152) of the pin (118) and secured by the end cap (120). The extension spring (44) has a first end (156) engaged with a tab (158) of the cage (32) (shown only in FIG. 2) and a second end (161) engaged with a flange (162) formed on the carriage (144). Thus, the extension spring (44) biases the carriage (144) away from the blade assembly (26) and urges the anvil (36) toward the adjustment cams (38).

The example anvil assembly (28) also includes a position sensor in the form of an optical sensor (164) that is secured to the support plate (30). A pair of arms (166) extend from a bracket (168) and flank the adjustment gear (122). Specifically, the adjustment gear (122) includes an opening (170) through the adjustment gear (122) such that the optical sensor (164) may send a signal to a controller (not shown) of the label printer (10) when the opening (170) in the adjustment gear (122) is aligned with the arms (166) of the optical sensor (164). Again, as one skilled in the art will appreciate, a variety of sensors may be incorporated and techniques employed to determine the rotational position of the adjustment gear (122).

The components of an alternative anvil assembly (300) are illustrated in FIG. 7B. A pin (310) includes an upper flange (312) and a lower flange (314). A lower adjustment cam (316) is positioned adjacent the lower flange (314). A lower stopper (318) is slide along the pin (310) and rotatably interlocked with the lower adjustment cam (316) by a protrusion (320) extending from the lower stopper (318) that mates with a recess (322) formed in the lower adjustment cam (316). The lower stopper (318) is also rotationally fixed to the pin (310) via a D-shaped opening (319) that mates with a D-shaped portion (336) of the pin (310). The lower adjustment cam (316) and lower stopper (318) are axially restrained to the pin (310) by an e-clip (324) secured in a groove (326) formed in the pin (310). An adjustment gear (328) having a plurality of teeth (330) is rotatably coupled to the pin (310). A central hub (332) of the adjustment gear (328) includes a D-shaped opening (334) mating with the D-shaped portion (336) of the pin (310).

A carriage (338) includes an opening (340) through which the pin (310) extends. An anvil (342) includes a pair of bent legs (344) that are hooked over respective arms (346) formed in an end (348) of the carriage (338). A body portion (350) of the anvil (342) is positioned generally between the arms (346) when the anvil (342) is coupled to the carriage (338). An upper adjustment cam (352) is seated adjacent the upper flange (312). An upper stopper (354) is slid along the pin (310) and rotatably interlocked with the upper adjustment cam (352) by a protrusion (357) extending from the upper stopper (354) that mates with a recess (356) formed in the upper adjustment cam (352). The upper stopper (354) is also rotatably fixed to the pin (310) via a D-shaped opening (355) that mates with another D-shaped portion (337) of the pin (310). The upper adjustment cam (352) and upper stopper (354) are axially restrained to the pin (310) by a cap (not shown), similar to the first anvil assembly (28).

Similar to the first anvil assembly (28), the first end (156) of the extension spring (44) is engaged with a tab (33) of the cage (32) (shown only in FIG. 2) and the second end (161) is engaged with a flange (358) formed on the carriage (338). Thus, the extension spring (44) biases the carriage (338) away from the alternative blade assembly (210) and urges the anvil (342) toward the adjustment cams (316, 352).

Turning to the interaction of the adjustment cams (38) and the anvil (36) and with additional reference to FIGS. 8-13, rotating the adjustment cams (38) about the adjustment cam axis (40) will adjust the position of the anvil (36) relative to the adjustment cam axis (40), and hence the gap (56) between the cutting blade (34) and the cutting surface (54) of the anvil (36) when the cutting blade (34) is in the extended position. Operation of the example label printer (10) preferably incorporates the step of moving the anvil assembly (28) and the blade assembly (26) into home positions, which have a known orientation such that a controller may logically control operation of the anvil assembly (28) and blade assembly (26) from the respective home positions. Therefore, given application specific print media parameters (e.g., type, form factor, dimensions, and the like) the cutter system (20) may be adjusted to a cutting position and operated to achieve desired application specific depth of cut parameters (e.g., full cut, partial cut, alternating depth, and the like).

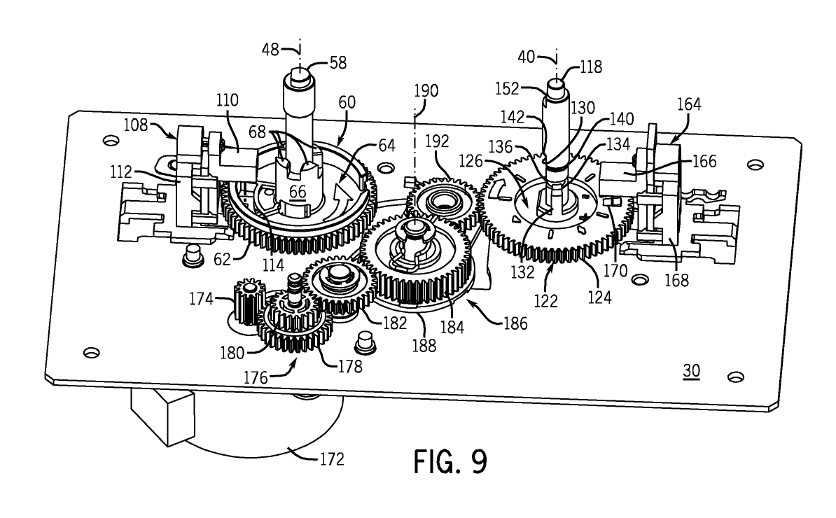

In the example label printer (10), the anvil assembly (28) and the blade assembly (26) are operated by a single drive mechanism. With specific reference to FIG. 9, an example gear train is depicted having a motor in the form of a step motor (172) that is secured to the support plate (30) and includes a drive gear (174) fixed to a drive shaft (175). Rotating the step motor (172) in the counterclockwise direction (as generally shown in FIG. 9) engages the drive gear (174) with a stacked gear (176), specifically the bottom gear (178) of the stacked gear (176), which in turn rotates a top gear (180) of the stacked gear (176) in the clockwise direction. The top gear (180) of the stacked gear (176) engages an idler gear (182) to rotate the idler gear (182) in the counterclockwise direction. The idler gear (182) in turn rotates an input gear (184) of a rocker arm assembly (186) in a clockwise direction. The rocker arm assembly (186) includes a rocker plate (188) pivotally coupled to the support plate (30) about a rocker arm axis (190). The clockwise rotation of the input gear (184) urges the rocker plate (188) clockwise about the rocker arm axis (190) to engage an output gear (192) with the adjustment gear (122). The output gear (192) is rotating counterclockwise due to engagement with the input gear (184), thus the adjustment gear (122) is rotated clockwise. The step motor (172) is rotated counterclockwise until the optical sensor (164) senses the opening (170) formed in the adjustment gear (122), thus indicating a known position of the adjustment gear (122) and engaged anvil (36). As noted, with the adjustment gear (122) in the known position, subsequent operation of the step motor (172) may adjust the anvil assembly (28) as desired for a particular application.

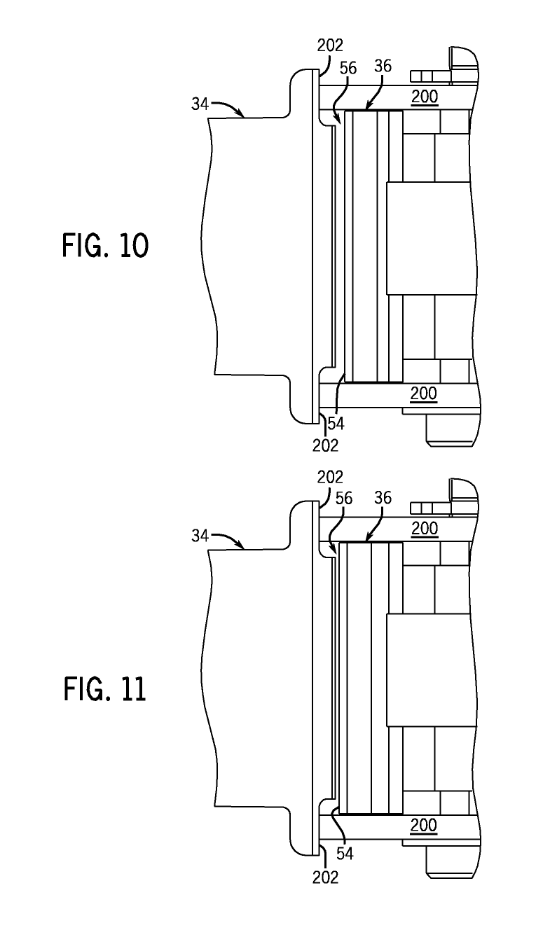

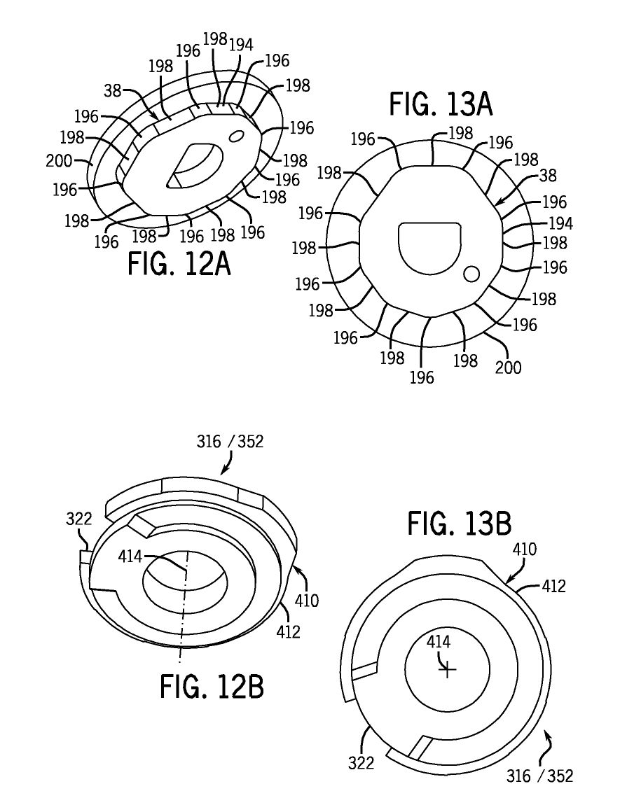

As the adjustment gear (122) is rotated, a cam surface (194) of the adjustment cam (38) (best shown in FIGS. 12A and 13A) rotates about the adjustment cam axis (40). As the cam surfaces (194) are rotated, the carriage (144) (and coupled anvil (36)) is urged against the cam surfaces (194) by the extension spring (44) coupled to the carriage (144). As a result, when viewed in FIG. 8, the anvil (36) translates generally left and right along the cutting plane (52), which is defined generally along a plane extending from the cutting blade (34) and perpendicular to the cutting surface (54) of the anvil (36).

With the anvil (36) in a known position, and with continued reference to FIG. 9, the step motor (172) is rotated in the clockwise direction to ultimately rotate the cutting gear (60). Rotating the step motor (172) in the clockwise direction (as generally shown in FIG. 9) engages the drive gear (174) with the stacked gear (176), specifically the bottom gear (178) of the stacked gear (176), which in turn rotates the top gear (180) of the stacked gear (176) in the counterclockwise direction. The top gear (180) of the stacked gear (176) engages the idler gear (182) to rotate the idler gear (182) in the clockwise direction. The idler gear (182) in turn rotates the input gear (184) of the rocker arm assembly (186) in a counterclockwise direction. The counterclockwise rotation of the input gear (184) urges the rocker plate (188) counterclockwise about the rocker arm axis (190) to engage the output gear (192) with the cutting gear (60). The output gear (192) is rotating clockwise due to engagement with the input gear (184), thus the cutting gear (60) is rotated counterclockwise. Again, the step motor (172) is rotated clockwise until the optical sensor (108) senses the opening (114) formed in the cutting gear (60), thus indicating a known position of the cutting gear (60) and coupled cutting blade (34).

With the anvil assembly (28) and blade assembly (26) in known orientations, parameters of the particular application may be input into the label printer (10), such as via keyboard entry, barcode scanning, radio frequency identification, communication between the label printer (10) and the media cartridge (16), and the like. For instance, the diameter and wall thickness of a particular type of polyolefin sleeve in combination with the desired depth of cut (e.g., partial cut), may be used (in connection with the known contour of the cam surface (194) of the adjustment cam (38)) to actuate the step motor (172) a discrete number of steps required to establish the desired gap (56) (including a full/complete cut with no gap (56)). That is, a certain number of steps of the step motor (172) in the counterclockwise direction (as viewed in FIG. 9) will move the anvil (36) from the known position to a desired position to achieve the request depth of cut into or through the print media fed between the cutting blade (34) and the anvil (36). With the anvil (36) positioned accordingly, the step motor (172) is rotated in the opposite direction to ultimately move the blade holder (50) and coupled cutting blade (34) from the retracted position to the extend position, thereby cutting into the print media.

As noted above, the gap (56) may be adjusted between no gap, allowing for the cutting blade (34) to cut completely through the print media, and a maximum gap, allowing the cutting blade (34) to cut some depth less than completely through the print media. An example intermediate gap (56) is shown generally in FIG. 11. In the example adjustment cams (38), the cam surface (194) includes a plurality of lobes (196) (spaced circumferentially about a perimeter of the adjustment cam (38)) connected by lands (198) between adjacent lobes (196) that are used to adjust the gap (56) between the no gap and the maximum gap. The engagement surface (42) of the anvil (36) preferably bears against the lands (198) during a cutting operation for increased stability; however, depending upon the gap (56) desired, any portion of the cam surface (194) may be used as a bearing surface for the anvil (36). Given this disclosure, one skilled in the art will appreciate the various profiles and contours available to define the cam surface (194). For instance, the cam surface (194) may include a generally eccentric circle defining a relatively smooth transitioning cam surface (194) or a curved teardrop shape, as generally viewed from the perspective shown in FIG. 13A. In some forms, the cam surface (194) is preferably contoured to minimize audible noise during operation by minimizing any discrete steps formed in the cam surface (194).

Another alternative cam profile is shown in FIGS. 12B and 13B. Specifically, the contours of the example lower adjustment cam (316) and upper adjustment cam (352) are shown having a cam surface (410) with a portion (412) defining a gradually increasing radial distance from an axis of rotation (414). Thus, the lower adjustment cam (316) and upper adjustment cam (352) may be rotated to establish a precise gap (56) of an almost infinite size between the maximum gap and the no gap established by the extremes of the cam surface (410).

In the example embodiment, the adjustment cams (38) include integrally formed anvil stops (200), in the form of disk-shaped plates having a generally uniform radius relative to the adjustment cam axis (40). Additionally, the example cutting blade (34) includes integrally formed blade stops in the form of legs (202) that extend laterally beyond the cutting portion of the cutting blade (34). With specific reference to FIGS. 10 and 11, the anvil stops (200) and blade stops (e.g., legs (202)) are configured to engage when the adjustment cams (38) are oriented in any position, excluding the no gap position at which the gap (56) is closed such that the cutting blade (34) directly contacts the cutting surface (54) of the anvil (36) to completely cut through the print media (shown in FIG. 15). The anvil stops (200) and blade stops (e.g., legs (202)) generally define an example stopper that is positioned to inhibit relative movement between the cutting blade (34) and the anvil (36) along the cutting plane (52) when the cutting blade (34) is in the extended position. The stopper need not comprise two discrete contours or structures; instead, a stopper may be any structural configuration that engages when the cutting blade (34) is in the extended position to provide added stability.

In the illustrated example cutter system (20), the blade assembly (26) is moved from the retracted position to the fully extended position during each cutting cycle. However, as one skilled in the art will appreciate given the benefit of this disclosure, the blade assembly (26) need not fully extend the cutting blade (34) in some embodiments. For instance, the step motor (172) may include torque sensing or current sensing that is monitored by the controller such that the cutting blade (34) is only actuated toward the fully extended position until a predetermined level of torque is supplied or current is drawn by the step motor (172), indicating that the stopper has been engaged and the desired cut depth achieved.

Given the benefit of this disclosure, one skilled in the art will appreciate various modifications to the above concepts that may be made. For instance, while the example stopper includes a pair of anvil stops (200) in the form of disks rotatably fixed to respective adjustment cams (38), the stopper may be fixed relative to the adjustment cams (38) or may be integrated solely with the blade holder (50) to engage a portion of the anvil assembly (28) or cage (32). The rotatable stopper arrangement is preferred to distribute wear caused by engagement between the anvil stop (200) and the blade stop (e.g., leg 202)).

As another variation, the anvil (36) and adjustment cam (38) may be integral, such that the cam surface (194) is directly engaged by the cutting blade (34) and/or stopper. Conversely, a single adjustment cam may be rotatably coupled to the adjustment gear (122) about the adjustment cam axis (40) such that the carriage (144) bears against the adjustment cam. In other versions, the anvil may be fixed, with the stoppers engaging to provide the desired gap, that is, the stoppers may rotate relative to the fixed anvil to limit the proximity of the cutting blade relative to the anvil when the cutting blade is extended. In this version, the movement of the cutting blade must be configured to allow for less-than-complete actuation along the cutting plane (52). Alternatively, the stoppers may be fixed and the anvil moveable.

In yet another variation, the sensors (108, 164) used to sense the position of the cutting gear (60) and adjustment gear (122), respectively, may be replaced by an arrangement of gears incorporating a driven gear having a no-teeth zone. In one example, a drive gear in engagement with the driven gear will rotate the driven gear until teeth of the drive gear enter the no-teeth zone of the driven gear. At this point, the driven gear will be oriented generally in a known position. Another drive gear circumferentially spaced from the location of the no-teeth zone is then able to engage and drive the driven gear to rotate the driven gear to the desired cutting position. In addition, various brake springs and catches may be incorporated to control the movement and positioning of the gears.

While there has been shown and described what is at present considered the preferred embodiments of the invention, it will be appreciated by those skilled in the art, given the benefit of this disclosure, that various additional changes and modifications can be made without departing from the scope of the invention defined by the following claims.

We claim:

1. An adjustable print media cutter system capable of use in a printer, comprising:
a frame;
a cutting blade slideably mounted to the frame along a cutting plane between a retracted position and an extended position;
an anvil mounted to the frame adjacent the cutting blade and intersecting the cutting plane;
a stopper positioned adjacent the cutting blade and the anvil to selectively inhibit relative movement between the cutting blade and the anvil along the cutting plane when the cutting blade is in the extended position; and
an adjustment cam coupled to the frame and engaged with at least one of the anvil and the stopper;
wherein rotation of the adjustment cam about an adjustment cam axis moves at least one of the anvil and the stopper along the cutting plane adjusting a gap between the cutting blade and the anvil that establishes a depth of cut by the cutting blade into or through a print media that is fed between the cutting blade and the anvil.

2. The adjustable print media cutter system of claim 1, wherein the anvil and the adjustment cam are integral.

3. The adjustable print media cutter system of claim 1, wherein:
the adjustment cam includes a pair of adjustment cams;
the pair of adjustment cams engage the anvil; and
the stopper includes a pair of stoppers spaced apart along the adjustment cam axis.

4. The adjustable print media cutter system of claim 1, wherein the adjustment cam includes a plurality of lobes spaced circumferentially about a periphery of the adjustment cam.

5. The adjustable print media cutter system of claim 1, wherein the stopper is fixed to the frame.

6. The adjustable print media cutter system of claim 1, further comprising:
a carriage coupled to the anvil and moveable along the cutting plane between a no gap position and a maximum gap position; and
a biasing member coupled between the carriage and the frame urging the carriage away from the cutting blade.

7. The adjustable print media cutter system of claim 1, further comprising a motor operationally coupled to the adjustment cam to selectively rotate the adjustment cam about the adjustment cam axis.

8. The adjustable print media cutter system of claim 7, further comprising:
a cutting cam rotatably coupled to the frame and engaged with the cutting blade to move the cutting blade toward the extended position;
a cutting gear coupled to the cutting cam;
an adjustment gear coupled to the adjustment cam; and
a rocker arm pivotally coupled to the frame and having an input gear and an output gear;
wherein the motor includes an output shaft operationally coupled to the input gear of the rocker arm; and
wherein rotation of the motor in a first direction causes the rocker arm to pivot such that the output gear engages the cutting gear to rotate the cutting cam, and rotation of the motor in a second direction opposite the first direction causes the rocker arm to pivot such that the output gear engages the adjustment gear to rotate the adjustment cam.

9. The adjustable print media cutter system of claim 1, further comprising:
a blade holder supporting the cutting blade; and
a biasing member coupled between the blade holder and the frame urging the blade holder away from the anvil.

10. The adjustable print media cutter system of claim 1, further comprising:
a cutting cam rotatably coupled to the frame and engaged with the cutting blade to move the cutting blade toward the extended position; and
wherein the cutting cam includes a lobed cam surface spaced apart from a cutting cam axis and defining a lower torque region and a higher torque region.

11. An adjustable print media cutter system capable of use in a printer, comprising:
a frame;
a cutting blade slideably mounted to the frame along a cutting plane between a retracted position and an extended position;
an anvil slideably mounted to the frame along the cutting plane between a first gap position and a second gap position; and
an adjustment cam rotatably coupled to the frame about an adjustment cam axis, and engaged with the anvil;
wherein rotation of the adjustment cam about the adjustment cam axis moves the anvil along the cutting plane between the first gap position and the second gap position, thereby adjusting a gap between the cutting blade and the anvil that establishes a depth of cut by the cutting blade into or through a print media that is fed between the cutting blade and the anvil.

12. The adjustable print media cutter system of claim 11, wherein:
the first gap position is a no gap position; and
the second gap position is a maximum gap position.

13. The adjustable print media cutter system of claim 12, further comprising:
a stopper, comprising:
a disk adjacent the adjustment cam; and
a leg adjacent the cutting blade;
wherein when the anvil is spaced apart from the no gap position and the cutting blade is in the extended position, the leg abuts the disk.

14. The adjustable print media cutter system of claim 13, wherein the disk is oriented substantially perpendicular to the cutting plane.

15. The adjustable print media cutter system of claim 11, further comprising:
a carriage coupled to the anvil and moveable along the cutting plane between the first gap position and the second gap position; and
a biasing member coupled between the carriage and the frame urging the carriage away from the cutting blade.

16. The adjustable print media cutter system of claim 11, further comprising a motor operationally coupled to the adjustment cam to selectively rotate the adjustment cam about the adjustment cam axis.

17. The adjustable print media cutter system of claim 16, further comprising:
a cutting cam rotatably coupled to the frame and engaged with the cutting blade to move the cutting blade toward the extended position;
a cutting gear coupled to the cutting cam;
an adjustment gear coupled to the adjustment cam; and
a rocker arm pivotally coupled to the frame and having an input gear and an output gear;
wherein the motor includes an output shaft operationally coupled to the input gear of the rocker arm; and
wherein rotation of the motor in a first direction causes the rocker arm to pivot such that the output gear engages the cutting gear to rotate the cutting cam, and rotation of the motor in a second direction opposite the first direction causes the rocker arm to pivot such that the output gear engages the adjustment gear to rotate the adjustment cam.

18. A method of adjusting a print media cutter system capable of use in a printer, comprising:
providing a print media cutter system, comprising:
a frame;
a cutting blade slideably mounted to the frame along a cutting plane between a retracted position and an extended position;
an anvil mounted to the frame adjacent the cutting blade and intersecting the cutting plane;
a gap defined between the cutting blade and the anvil; and
an adjustment cam rotatably coupled to the frame about an adjustment cam axis;
rotating the adjustment cam about the adjustment cam axis to adjust the gap between the cutting blade and the anvil.

19. The method of adjusting a print media cutter system of claim 18, wherein:
the print media cutter system further comprises a motor operationally coupled to rotate the adjustment cam; and
further comprising energizing the motor to rotate the adjustment cam to a known position.

20. The method of adjusting a print media cutter system of claim 19, further comprising energizing the motor to rotate the adjustment cam from the known position to a cutting position to establish a desired gap, wherein the desired gap is between no gap and a maximum gap.
